(19) United States
(12) Patent Application Publication
(10) Pub. No.: US 2013/0132489 A1
(43) Pub. Date: May 23, 2013

(54) LOCATION-BASED SOCIAL NETWORKING

(71) Applicants: Sheng Chao Huang, Edmonton (CA); Ho Yin Li, Edmonton (CA)

(72) Inventors: Sheng Chao Huang, Edmonton (CA); Ho Yin Li, Edmonton (CA)

(21) Appl. No.: 13/356,350

(22) Filed: Jan. 23, 2012

Related U.S. Application Data
(60) Provisional application No. 61/563,483, filed on Nov. 23, 2011.

(51) Int. Cl. G06F 15/173

(52) U.S. Cl. 709/206; 709/223

(57) ABSTRACT

A system incorporating techniques described in this paper includes a bubble server capable of facilitating the creation of location-based virtual networks (“bubbles”) that bubble clients can join. Bubble clients can be implemented on mobile devices that can contact the bubble server via a network connection.

### CROSS-REFERENCE TO RELATED APPLICATIONS

This application claims priority to U.S. provisional Ser. No. 61/563,483 filed Nov. 23, 2011, entitled “A mobile phone application for location based social networking. An individual can create or join location based chat rooms to communicate with smart phone users within each predefined participation zone of the chat room;” which is incorporated by reference.

### BACKGROUND

Social networking is an area of active development. Any improvement in the state of the art is generally seen as significant due to the activity in the area. A social network system can include a datastore of contacts for a user. The user can communicate with any of the contacts using the relevant medium (e.g., if the contact includes a telephone number, the communication can be by phone). What is generally lacking in the state of the art is a system that enables group discussion for individuals in a common location. This can be due to a lack of ability to find others to engage in group conversations, to review discussion topics, and/or privacy when attempting to join a new group.

The foregoing example of desirable areas of research and development that are lacking in the state of the art are intended to be illustrative and not exclusive. Techniques described in this paper address, reduce, or eliminate these problems.

### SUMMARY

A system incorporating techniques described in this paper facilitates group discussion between multiple mobile devices in a common location area. A mobile user can find and engage in group conversations with other mobile users. Mobile users can review discussion topics and decide whether to join the discussion. The system protects mobile users' privacy by keeping personal information confidential.

To create a discussion, a mobile user can turn-on a mobile device and run a client application. The client application determines the physical location of the mobile device by, for example, checking GPS modules. The mobile user enters a discussion topic. The client application sends the location and discussion topic parameters from the mobile device to a discussion server to register the discussion. After the discussion is successfully registered, a confirmation is sent from the discussion server back to the mobile device.

To search and join a discussion, a mobile user can turn-on a mobile device and run a client application. The client application determines the physical location of the mobile device by, for example, checking GPS modules. The client application sends the location parameter from the mobile device to a discussion server. Based on the location of the mobile device, the discussion server can retrieve registered discussions that are within a valid common area. The mobile user receives a list of valid discussions within the valid common area and can choose to join one or more of the discussions.

The medium can include an applicable known or convenient medium, which can include one-to-one messaging, one-to-many messaging, or many-to-many messaging media. The system can connect users to associates (e.g., contacts) or the system can be used to connect a user with an unknown party in a valid common area.

### BRIEF DESCRIPTION OF THE DRAWINGS

FIG. 1 depicts a conceptual diagram of a system of networks including topic bubbles.

FIG. 2 depicts an example of a location-based social networking system.

FIG. 3 depicts a flowchart of an example of a method for registering for a bubble service.

FIG. 4 depicts a flowchart of an example of a method for requesting a topic bubble.

FIG. 5 is a conceptual drawing of a system for enabling a host to start a topic bubble.

FIG. 6 depicts a conceptual diagram of a host anchoring and dropping a bubble.

FIG. 7 depicts a flowchart of an example of a method for joining a topic bubble.

FIG. 8 depicts a conceptual diagram of a bubble client joining a bubble.

FIG. 9 depicts a flowchart of an example of a method of participating in a bubble.

FIG. 10 depicts a flowchart of an example of a method of host bubble management.

FIG. 11 depicts a conceptual diagram of a bubble interface.

FIG. 12 depicts an example of a computer system on which techniques described in this paper can be implemented.

### DETAILED DESCRIPTION

Specific implementations of the invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. For the purpose of clarity, technical material that is known in the technical fields related to the invention has not been described in detail so that the invention is not unnecessarily obscured.

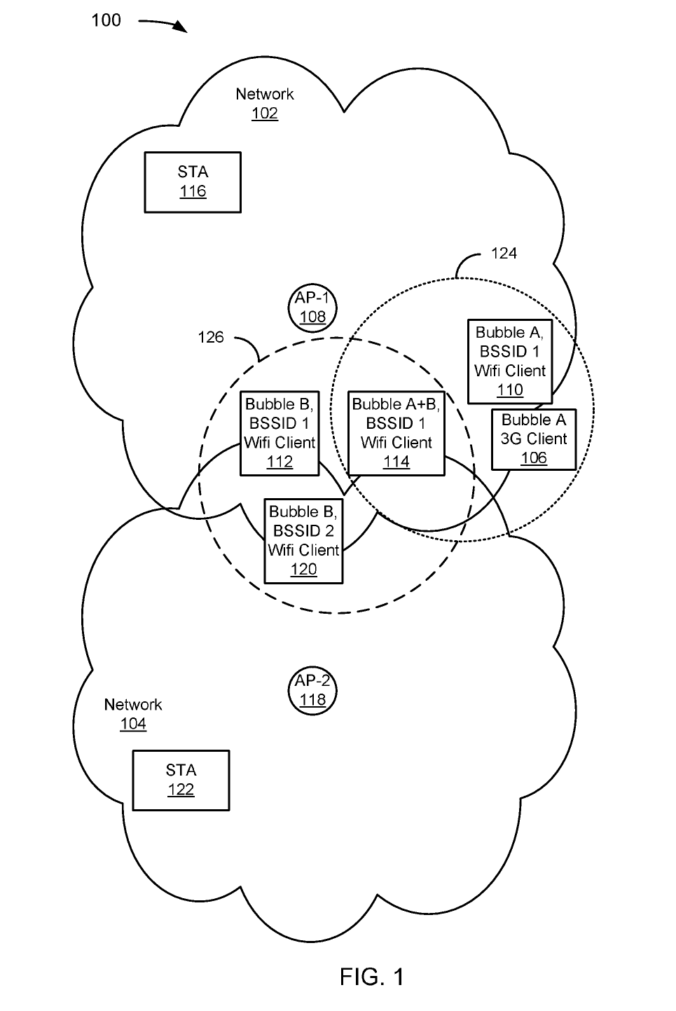

FIG. 1 depicts a conceptual diagram of a system of networks including topic bubbles. In the example of FIG. 1, the system 100 includes a network 102 and a network 104. The bubble A 3G client 106 is assumed to be on a third (cellular) network, which is not shown.

In the example of FIG. 1, the network 102 includes an access point 1 (AP-1) 108; a bubble A, BSSID 1 Wifi client 110; a bubble B, BSSID 1 Wifi client 112; a bubble A+B, BSSID 1 Wifi client 114; and a station (STA) 116. In the example of FIG. 1, the wireless network 102 can include a plurality of wireless transmit and/or receive nodes. A node will be referred to as an AP in this paper, though it should be recognized that terminology will vary depending upon the technology and/or implementation. For example, in an ad-hoc network the term “AP” is typically not used. For the sake of illustrative simplicity, since a person of skill in the relevant art will have no trouble in finding the relevant term in the Institute of Electrical and Electronic Engineers (IEEE) 802.11 standard, the current version of which is incorporated by reference, terms that are typically used in the 802.11 standard will be preferentially used in this paper when discussing wireless technology. It should be understood that different terminology may be used when referring to other wireless technology.

A station that is connected to the network 102 through the AP-1 108 can be referred to as “on” the network 102. A station that is not connected through the AP-1 108 of the network 102, but is sending or receiving radio frequency (RF) signals within range of the AP-1 108, might be referred to as operating within a wireless domain associated with the network 102, but would typically not be referred to as on the network 102. The AP-1 is associated with a basic service set (BSS), and typically broadcasts a BSSID for the BSS (in some cases the BSSID is not broadcast, and stations must know the BSSID to associate with the network). Multiple APs can make up an extended service set (ESS) of APs that can be treated as a single network. (Some networks include multiple APs that beacon the same BSSID, as well.) Regardless of the specific implementation of the network 102, it should be understood that the AP-1 108 is intended to represent one of potentially multiple APs that enable a station to get on the network 102. The specific network technology employed can be of an applicable known or convenient variety.

A station, as used herein, may be referred to as a device with a media access control (MAC) address and a physical layer (PHY) interface to the wireless medium that comply with the IEEE 802.11 standard. Since APs that comply with the 802.11 standard have these characteristics, an AP can be referred to as a station. Where it is desirable to draw a distinction between an AP and a non-AP station, the AP can be referred to as an “AP” and a station can be referred to as a “non-AP station.” In general, a station can comply with any wireless standard or none at all, and may have any known or convenient interface to a wireless or other medium, though depending upon the standard, a station may be referred to as something other than a “station,” and may have different interfaces to a wireless or other medium. Exhaustively listing every implementation of a station is difficult, but some examples include a laptop, a wireless telephone, portable digital assistant (PDA), a desktop computer, or any other applicable computing device capable of communication on a wireless network.

Depending upon the technology or implementation, an AP includes a hardware unit that acts as a communication hub by linking wireless mobile stations to a wired backbone network. This can, for example, enable APs to connect users to other users within the network and/or to serve as the point of interconnection between a wireless local area network (WLAN) and a fixed wire network. The number of APs that are desirable for a given implementation can depend upon the desired size of a wireless domain. For example, it may be desirable to locate the APs such that they cover the entire area/space of a wireless domain. The number of APs that are desirable for a given implementation can also depend upon whether data from the APs is used to get a snapshot of where stations, or a subset of the stations, are located within the wireless network; generally, the more APs, the better, though at some point there is likely to be diminishing returns.

In operation, an AP can typically transmit and receive data (and may therefore be referred to as a transceiver) using one or more radio transmitters. For example, an AP can have two associated radios, one which is configured for 5 GHz transmissions, and the other which is configured for 2.4 GHz transmissions. (Other bands are acceptable, too.) In a non-limiting embodiment, APs transmit and receive information as radio frequency (RF) signals to and from a wireless station over an Ethernet connection. APs can transmit and receive information to and from their associated wireless exchange switches. Connection to a second wireless exchange switch provides redundancy.

Bubble A, BSSID 1 Wifi client 110 is on the network 102. What it means to be part of “Bubble A” is described in more detail later. “BSSID 1” is intended to indicated that the client 110 is operationally connected through the AP-1 108 to the network 102. Bubble A, BSSID 1 Wifi client 110 can be referred to as a station. At a minimum, a station will include a processor, memory (though the memory could be implemented in the processor), a radio, and a radio interface (though the radio interface could be implemented as “part of” the radio). In order to make a station useful in a user device implementation, stations implemented on user devices will typically have at least one input device and at least one output device, including input and output interfaces, if applicable. A station, as used herein, may be referred to as a device with a media access control (MAC) address and a physical layer (PHY) interface to the wireless medium that comply with, e.g., cellular standards or the IEEE 802.11 standard. A station can be described as “IEEE 802.11-compliant” when compliance with the IEEE 802.11 standard is intended to be explicit. (I.e, a device acts as described in at least a portion of the IEEE 802.11 standard.) One of ordinary skill in the relevant art would understand what the IEEE 802.11 standard comprises today and that the IEEE 802.11 standard can change over time, and would be expected to apply techniques described in this paper in compliance with future versions of the IEEE 802.11 standard if an applicable change is made. IEEE Std 802.11 ™-2007 (Revision of IEEE Std 802.11-1999) is incorporated by reference. IEEE 802.11k-2008, IEEE 802.11n-2009, IEEE 802.11p-2010, IEEE 802.11r-2008, IEEE 802.11w-2009, and IEEE 802.11y-2008 are also incorporated by reference. In alternative embodiments, one or more of the wireless devices may comply with some other standard or no standard at all, and may have different interfaces to a wireless or other medium. It should be noted that not all standards refer to wireless devices as “stations,” but where the term is used in this paper, it should be understood that an analogous unit will be present on all applicable wireless networks. Thus, use of the term “station” should not be construed as limiting the scope of an embodiment that describes wireless devices as stations to a standard that explicitly uses the term, unless such a limitation is appropriate in the context of the discussion.

The bubble B, BSSID 1 Wifi client 112 is on the same network 102 as the bubble A, BSSID 1 Wifi client 110, but is part of “bubble B” instead of “bubble A.” The bubble A+B, BSSID 1 Wifi client 114 is on the same network 102 as the bubble A, BSSID 1 Wifi client 110 and the bubble B, BSSID 1 Wifi client 112, and is part of both “bubble A” and “bubble B.” The station 116 is intended to illustrate that there can be other stations on the network 102, which can be part of the same or different bubbles as other stations, or no bubbles at all. It should be noted that a network 102 can include stations that are part of a single bubble. (The fact that two bubbles, bubble A and bubble B, are illustrated in the example of FIG. 1 should not suggest that there must be a plurality of bubbles on the network 102 or that if there is a plurality, it should be limited to two.)

In the example of FIG. 1, the network 104 includes an access point 2 (AP-2) 118; a bubble B, BSSID 2 Wifi client 120; and a station (STA) 122. The AP-2 118 is associated with the BSSID 2. The bubble B, BSSID 2 Wifi client 120 is on the BSSID 2 and is also in the bubble B with bubble B, BSSID 1 Wifi client 112. The station 122 is intended to illustrate that other stations, either in the same or different bubbles or no bubble at all, can also be on the network associated with AP-2 118.

In the example of FIG. 1, the bubbles are illustrated as covering a portion of each of the BSSIDs 1 and 2. However, an implementation can include a bubble that spans the entirety of the BSSIDs 1 and 2. This is particularly likely because BSSIDs typically cover a relatively small area; so location-based topic bubbles are likely to be applicable to the area that is covered. In a specific implementation, bubbles can cover ESSIDs (or networks with APs that beacon the same BSSIDs). This is because ESSIDs are also relatively small.

There is theoretically no limit to the size of a network that a bubble covers. However, because the bubbles are location-specific, it is not likely interesting to allow the bubble to expand in size to include a large network, such as a WAN (e.g., the Internet). A specific implementation is on the LAN level, with WLANs that extend into a given geographic (or other identifiable) area occupying the same space as the bubble. Appropriately configured stations on the WLANs that occupy the same space as the bubble can join the bubble. In a specific implementation, exceptions to the location limitation are made for certain entities. For example, a topic bubble that covers a university campus started by a professor could enable the professor to stay in the bubble regardless of where the professor roams (even, e.g., when the professor goes home). As another example, experts, superusers, or the like could start topic bubbles from a location that is not in the same space as a bubble (e.g., for a fee).

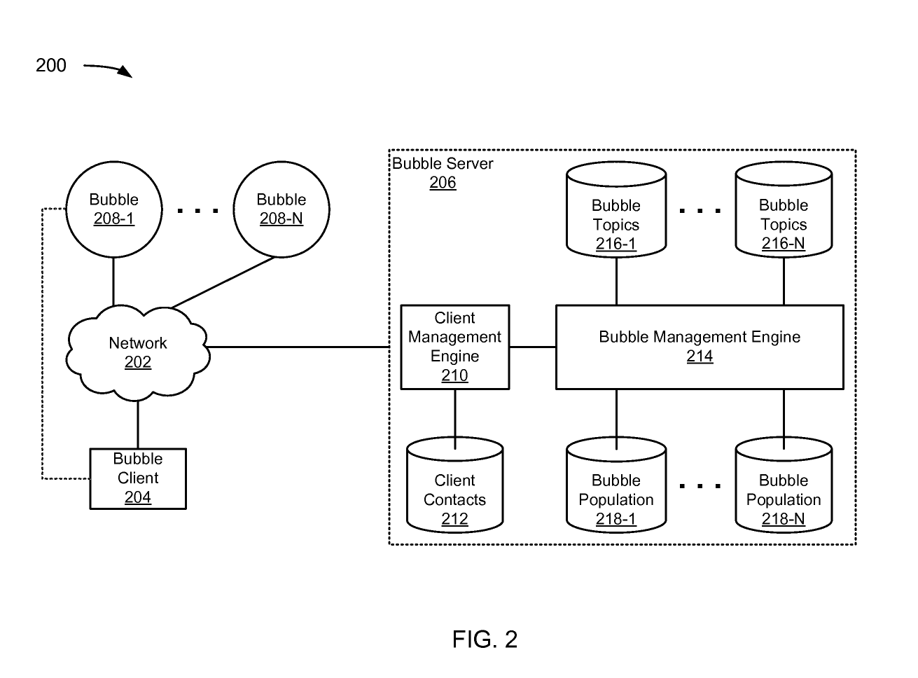

FIG. 2 depicts an example of a location-based social networking system 200. In the example of FIG. 2, the system 200 includes a network 202, a bubble client 204, a bubble server 206, and bubbles 208-1 to 208-N (referred to collectively as the bubbles 208).

In the example of FIG. 2, the network 202 is intended to include an applicable communications network such as the Internet, a public switched telephone network (PSTN), an infrastructure network (e.g., private LAN), or some other network that is capable of acting as a link between the various components depicted in FIG. 2. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (the web). A PSTN can include wired or wireless (e.g., 4G/3G/2G) network operated by, for example, a central provider. An infrastructure network that offers wireless connectivity can include wired and wireless devices in communication with wireless access points (WAPs). The wired and wireless devices can include various network equipment including by way of example but not limitation a cable network head end, a DSL network DSLAM, a fiber network aggregation node, and/or a satellite network aggregation node.

The network 202, if it includes a wireless network, will typically include an internetworking unit (IWU) that interconnects wireless devices on the network 202 with another network, such as a wired LAN on the network 202. The IWU is sometimes referred to as a wireless access point (WAP). In the IEEE 802.11 standard, a WAP is also defined as a station. Thus, a station can be a non-WAP station or a WAP station. In a cellular network, the WAP is often referred to as a base station. The network 202 can be implemented using any applicable technology, which can differ by network type or in other ways. The network 202 can include networks of any appropriate size (e.g., metropolitan area network (MAN), personal area network (PAN), etc.). Broadband wireless MANs may or may not be compliant with IEEE 802.16, which is incorporated by reference. Wireless PANs may or may not be compliant with IEEE 802.15, which is incorporated by reference. Networks can be identifiable by network type (e.g., 2G, 3G, WiFi), service provider, WAP/base station identifier (e.g., WiFi SSID, base station and sector ID), geographic location, or other identification criteria.

In the example of FIG. 2, the bubble client 204 coupled to the bubble server 206 through the network 202. In the example of FIG. 2, the bubble client 204 can be implemented as a station associated with a wireless network that is part of the network 202. In the example of FIG. 2, the bubble client 204 is coupled to the network 202. As has been described, the bubble client 204 can be implemented on a station. For example, the bubble client 204 can be implemented on a wireless user device such as a phone, personal data assistant (PDA), computing device, laptop, net book, tablet, camera, music/media player, GPS device, networked appliance, or some other known or convenient user device; and/or various types of intermediate networking devices. The user device may or may not be a wireless device, but the description often refers to the user device as a wireless device because it is a likely implementation in at least a subset of user cases.

In the example of FIG. 2, the bubble server 206 includes a client management engine 210, a client contacts datastore 212, a bubble management engine 214, bubble topics datastores 216-1 to 216-N (collectively referred to as the bubble topics datastores 216), and bubble population datastores 218-1 to 218-N (collectively referred to as the bubble population datastores 218). As used in this paper, an engine includes a dedicated or shared processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

In the example of FIG. 2, the client management engine 210 can include a variety of engines that enable a users to create, modify, or delete entries associated with their accounts. In an implementation that enables or requires a user account, a user with a user account can be alternatively referred to as a member of the bubble service provided by the bubble server 206. Such an implementation can include a guest login field/button, member login field/button, and a user registration field/button on a splash page, in addition to other content, such as a description of the service, EULA, etc.

In the example of FIG. 2, the client contacts datastore 212 is coupled to the client management engine 210. A datastore can be implemented, for example, as software embodied in a physical computer-readable medium on a general- or specific-purpose machine, in firmware, in hardware, in a combination thereof, or in an applicable known or convenient device or system. Datastores in this paper are intended to include any organization of data, including tables, comma-separated values (CSV) files, traditional databases (e.g., SQL), or other applicable known or convenient organizational formats. Datastore-associated components, such as database interfaces, can be considered “part of” a datastore, part of some other system component, or a combination thereof, though the physical location and other characteristics of datastore-associated components is not critical for an understanding of the techniques described in this paper.

Other datastores associated with a client can also be included, such as a user preferences datastore, account information datastore, or the like. The client contacts datastore 212 is depicted for illustrative reasons. Datastores can include data structures. Client contacts can be stored as data structures that are linked to relevant ones of the bubble population datastores 218. In this way, a member can determine which contacts of the member are in bubbles to which the member can join or monitor.

As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure.

In the example of FIG. 2, the bubble management engine 214 is coupled to the client management engine 210. The bubble management engine 214 can accept requests to form a bubble, create the requested bubble, populate the bubble, and terminate the bubble as appropriate. The bubble management engine 214 is coupled to the bubble topics datastores 216, and includes data associated with the bubble in data structures stored therein. A field of the data structure includes the topic, title, or other identifier of the bubble. The location of the bubble can be managed in a variety of ways. For example, if an AP is “in on it,” the AP can offer bubbles as a service. As another example, the bubble client 204 can create a bubble network as an ad hoc network. As another example, a field of the bubble topics datastores 216 can include location-specific data (e.g., GPS coordinates, location-relevant connection information, etc.) that is matched to a location of a bubble client that is looking for bubbles to join. When the bubble management engine 214 receives a request to view bubbles, the bubble management engine 214 can identify the bubbles that are near the requesting client, which can be displayed on a client device. When the bubble management engine 214 receives a bubble topic selection, the bubble management engine 216 can store the new bubble participant in a relevant one of the bubble population datastores 218. It may be noted that the bubble topics datastores 216 and the bubble population datastores 218 are depicted such that a bubble topics datastore 216-x and a bubble population datastore 218-x can correspond to one another. However, a reasonable physical implementation of the datastores is as a single bubble datastore with distinct bubble topics that are linked to a set of bubble participants.

In the example of FIG. 2, the bubbles 208 are coupled to the network 202. The bubbles 208 are depicted as distinct from the network 202 despite the fact that the bubbles 208 lie on top of networks that can be considered part of the network 202. In a specific implementation, the network 202 includes a set of wireless networks. In such an implementation, the bubbles 208 can include subsets of stations on the wireless networks. The dotted line from the bubble client 204 to the bubble 208-1 is intended to illustrate that the bubble client 204 is in the bubble 208-1. In a specific implementation, the bubble client 204 can be on a wireless network that is in the same space as the bubble 208-1. In this implementation, the bubble client 204 can join the bubble 208-1.

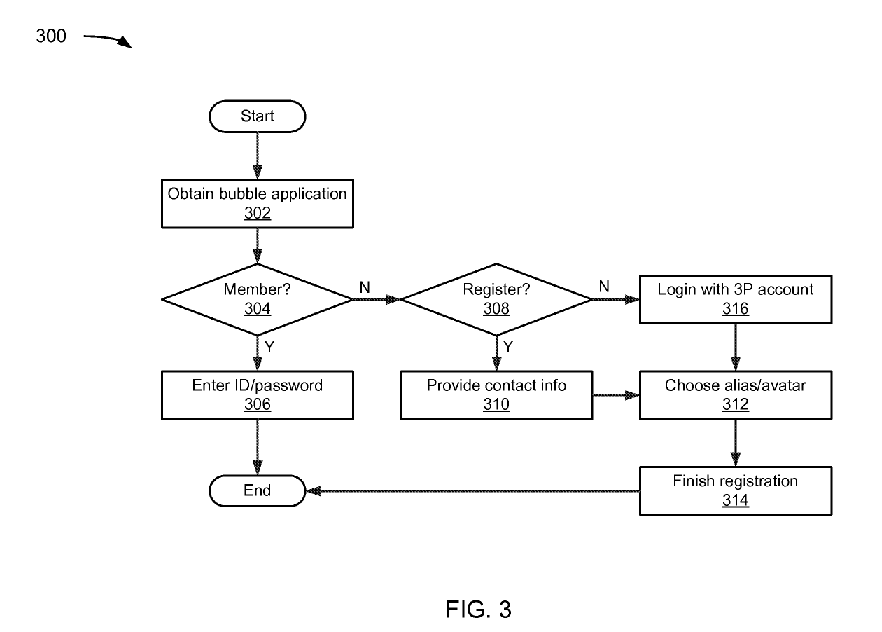

FIG. 3 depicts a flowchart 300 of an example of a method for registering for a bubble service. The flowchart 300, and other flowcharts in this paper, are illustrated as serially arranged modules and decision points, but it should be noted that the flowcharts could be reordered or arranged for parallel execution of certain modules. In the example of FIG. 3, the flowchart 300 starts at module 302 with obtaining a bubble application. In a specific implementation, the bubble application can be downloaded or streamed to a mobile device, such as an Android or iphone. Alternatively, a user could access a web site and enter relevant data to enable access to bubbles.

In the example of FIG. 3, the flowchart 300 continues to decision point 304 with determining whether a user is a member of a bubble service. If it is determined that the user is a member of the bubble service (304-Y), then the flowchart 300 continues to module 306 with entering an ID and password. It may be noted that the decision point 304 and the module 306 can be carried out in reverse order or at the same time by, e.g., presenting fields for entry of an ID and password and a button to “login” after the ID and password are entered. If a user enters a valid ID and password (306) and clicks “login,” then it will be determined that the user is a member (304-Y). After module 306, the flowchart 300 ends with the member having logged in to the bubble service.

In the example of FIG. 3, if it is determined that the user is not a member of the bubble service (304-N), then the flowchart 300 continues to decision point 308 where it is determined whether the user wishes to register as a member of the bubble service. If it is determined that the user wishes to register as a member of the bubble service (308-Y), then the flowchart 300 continues to module 310 with providing contact information. The contact information can include, for example, an email address or some other means for contacting the potential member. In the example of FIG. 3, the flowchart 300 continues to module 312 with choosing an alias/avatar. In a specific implementation, a member can choose an alias and an avatar, and can change the alias or avatar at a later time. In the example of FIG. 3, the flowchart 300 continues to module 314 with finishing registration. Finishing registration can include entering a username and a password (or being assigned a username and/or password), and providing other data that can vary depending upon the implementation and/or embodiment. The modules 310-314 can be reorganized with relative ease, or considered part of a single registration procedure. After module 314, the flowchart 300 ends with the member having registered for the bubble service. The member may or may not be required to login immediately after finishing registration (314), but in any case the next time the bubble service is accessed, the member can login as a member, skipping the registration process.

Referring once again to decision point 308, if it is determined that a user does not wish to register as a member of the bubble service (308-N), then the flowchart 300 continues to module 316 with logging in with a third party account. The third party account can include facebook, gmail, myspace, twitter, or some other account recognized by the bubble service system. The flowchart 300 continues to module 312 as described previously, though at module 314 different data can be gathered and/or the data can be gathered differently (e.g., by accepting data from the third party site), and the flowchart 300 ends with the user having logged in with a third party site. At this point, the user may or may not be registered as a member, which means the next time the user accesses the bubble service, the user may or may not be able to login as a member.

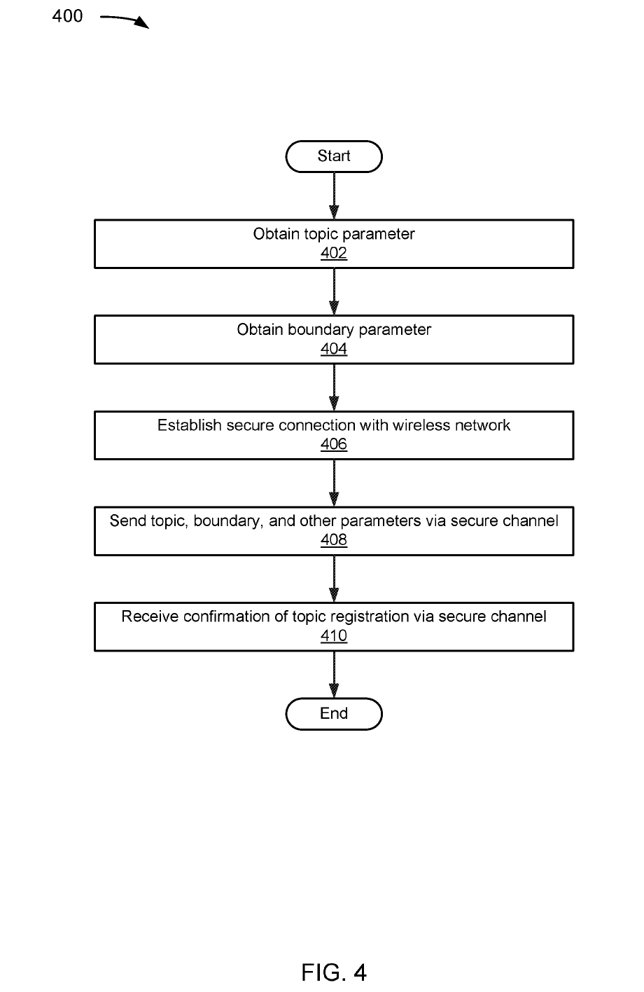

FIG. 4 depicts a flowchart 400 of an example of a method for requesting a topic bubble. In the example of FIG. 4, the flowchart 400 starts at module 402 with obtaining a topic parameter. In a specific implementation, the mobile device of a user receives user input of a topic that the user wishes to host the topic bubble. (In this paper, the “host” is the initiator of the bubble.) Depending upon the context, the “host” can refer to the user, the user's mobile device, or an agent of the user.

In the example of FIG. 4, the flowchart 400 continues to module 404 with obtaining a radius parameter. In a specific implementation, the mobile device of the user receives user input of an intended boundary of the topic bubble. The boundary can refer to a location, such as a city, a campus, or a building. In a specific implementation, the boundary parameter can refer to location data, such as street names, a GPS coordinate range, etc. In a specific implementation, the boundary parameter can include a radius identified using an applicable unit of measure. In a specific implementation, the boundary can include both location data (e.g., the location of the user's mobile device, a building, a neighborhood, a campus, etc.) and a radius. Some of the data can be received via a user input device, while others can be derived from a user account, packet data, etc.

In the example of FIG. 4, the flowchart 400 continues to module 406 with establishing a secure connection with a wireless network. A secure channel can be created thereby, using an applicable known or convenient technique.

In the example of FIG. 4, the flowchart 400 continues to module 408 with sending the topic, boundary, and/or other parameters via the secure channel. In a specific implementation, a client application engine on the mobile device of the user can send the parameters. In a specific implementation, the parameters are sent to a bubble server, which is a centralized or distributed engine serving client applications. In a specific implementation, the bubble server registers the topic and boundaries of the bubble with a unique ID along with a host ID (of the user initiating the bubble) and a mobile device ID (e.g., a MAC address or IP address associated with the mobile device) of the host.

In a specific implementation, the boundary parameter can be replaced with a privacy setting that limits the bubble to those who have applicable user parameters. For example, a host could host a bubble for only those users with a certain work email address. In another specific implementation, the host can be given the option of providing a location-based parameter or a “virtual” boundary that limits bubble participation to some user parameter other than location. In another specific implementation, the host can specify both a privacy parameter and a location-based boundary parameter.

In the example of FIG. 4, the flowchart 400 continues to module 410 with receiving confirmation of topic registration via the secure channel. In a specific implementation, the client application engine on the host's mobile device receives the confirmation of registration of the topic bubble from the bubble server. The confirmation can serve to inform the host that the topic bubble has been successfully created, and extends to the requested boundaries. It may be noted that the bubble server can change the topic and/or boundaries if appropriate. For example, it may be the policy that topics cannot include offensive language, in which case the topic can be modified at the server (the client application could also modify the topic or ensure that appropriate topics are entered); the topic could be modified to fit within a set number of topic categories; or the topic could be modified for some other reason. As another example, it may be desirable to limit the boundaries based on, for example, user account limitations, bubble size restrictions, or other parameters. Boundaries can also be translated from one location-parameter or unit of measure to another, either as a convenience for locals, as a preference, as a convenient estimate for a requested boundary, or for other reasons.

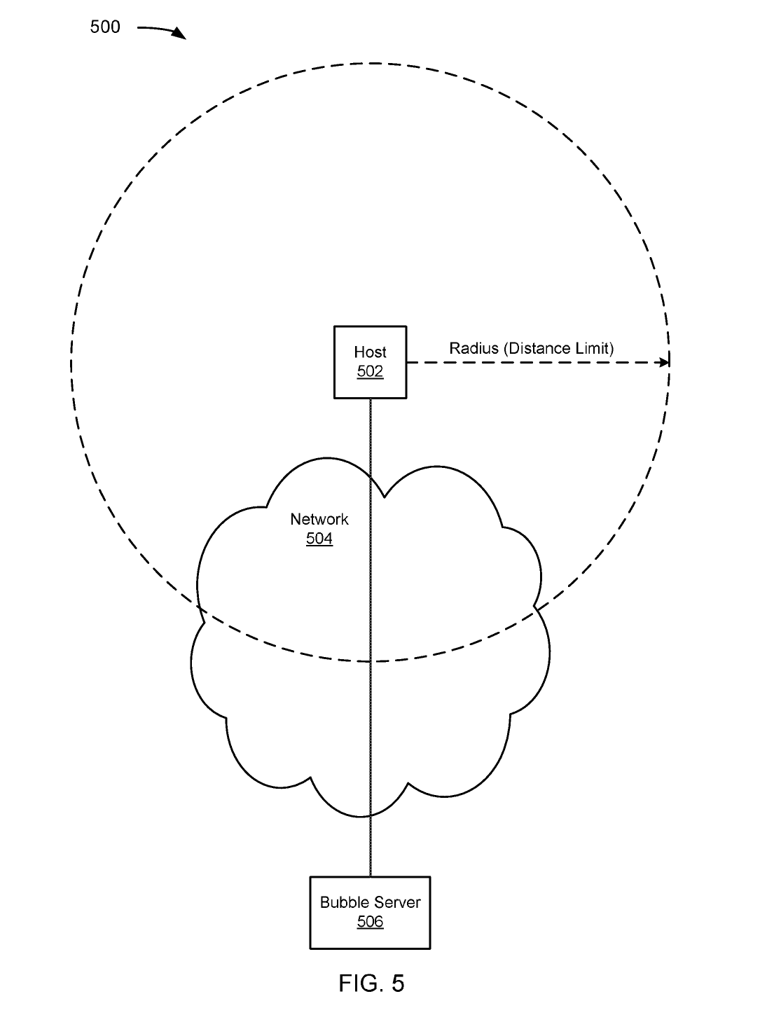

FIG. 5 is a conceptual drawing of a system 500 for enabling a host to start a topic bubble. The system 500 includes a host 502, a network 504, and a bubble server 506. The host can include a mobile device under the control of a member of a bubble service. A member at the host 502 can enter a topic into the mobile device and define boundaries (such as a radius) of a desired bubble. The host 502 establishes a connection to the network 504. When the connection is secure, a secure channel is established between the host 502 and the network 504.

In the example of FIG. 5, the network 504 can include a wireless network. For the purposes of this example, the host 502 is on the wireless network. The wireless network is coupled to another (typically wired) backbone network, which is, in turn, connected to a WAN, such as the Internet. There can be any applicable number of additional networks or subnetworks, or a combination of networks that differs from the current example, but a more detailed description of is not necessary for an understanding of the techniques described in this paper.

In the example of FIG. 5, the bubble server 506 receives the topic, boundary, and other parameters from the host 502. The bubble server 506 registers a discussion with a unique ID. The discussion is associated with a topic identifiable from the topic parameter and a distance limit from the host 502 that is identifiable from the boundary parameter. The bubble server 506 can also store a user ID and a device ID of the host 502 in association with the discussion. The server can send confirmation of registration of the discussion back to the host 502. A bubble client that is within the boundary of the bubble can see the topic and join the bubble (assuming the bubble is not a private bubble or restricted relative to the bubble client for some other reason).

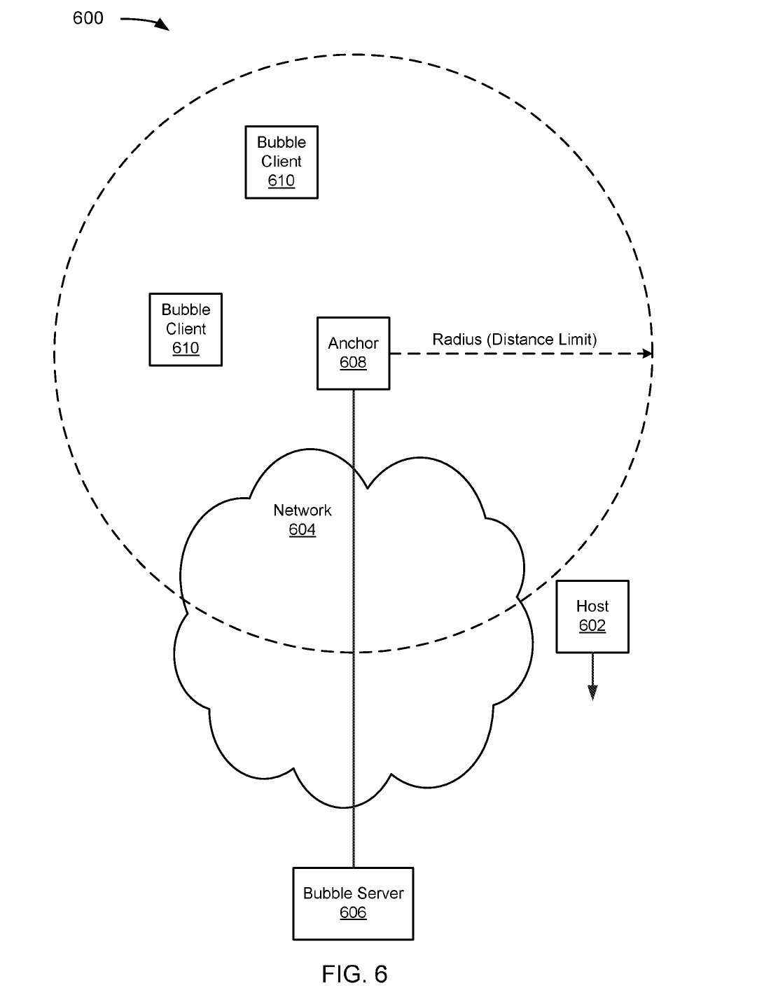

FIG. 6 depicts a conceptual diagram 600 of a host anchoring and dropping a bubble. In the example of FIG. 6, the diagram 600 includes a host 602, a network 604, a bubble server 606, an anchor 608, and bubble clients 610. By anchoring and dropping a bubble, a host can choose to leave a bubble when shutting down a mobile device (or running out of batteries), or leaving the boundary of the bubble. In the example of FIG. 6, the host 602 is depicted as outside of the bubble. (The arrow from the host 602 is intended to suggest that the host 602 is moving away from the bubble.)

In the example of FIG. 6, the network 604 and the bubble server 606 can be implemented as described with reference to FIG. 5.

In the example of FIG. 6, the anchor 608 represents the center of the bubble. An anchored bubble stays at the coordinates where the host anchors it, and continues to be available to bubble participants and/or other users who may wish to join the bubble after it has been anchored. It should be noted that the anchor 608 can be virtual. For example, the location of the bubble could be recorded at the bubble server, rather than at any particular device in the bubble. Depending upon the implementation, the host 602 could also choose another bubble client onto which to anchor the bubble, making the bubble client the de facto host. Depending upon the implementation, the host 602 can maintain some control over the bubble (control is discussed later in this paper) while within the area of the bubble, even after the bubble is anchored. The host 602 may or may not be able to return to an anchored bubble to reassert control over the bubble at a later time. In a specific implementation, bubbles can be created that are always anchored to a particular location (as opposed to moving with the host 602). If the host drops the bubble, that means the host is no longer in control of bubble characteristics. The term “detach” may also be used to describe a host anchoring and dropping a bubble.

In the example of FIG. 6, a plurality of bubble clients 610 are within the boundaries of the bubble. The bubble clients 610 may or may not be participants of the bubble. As long as the bubble clients 610 remain within the boundary of the bubble, the bubble clients can remain or become participants in the bubble. In a specific implementation, the bubble has an expiration time, at which point the bubble is terminated. The expiration time may or may not be set at the time the bubble is created, and may or may not be adjusted when the bubble is anchored and/or dropped.

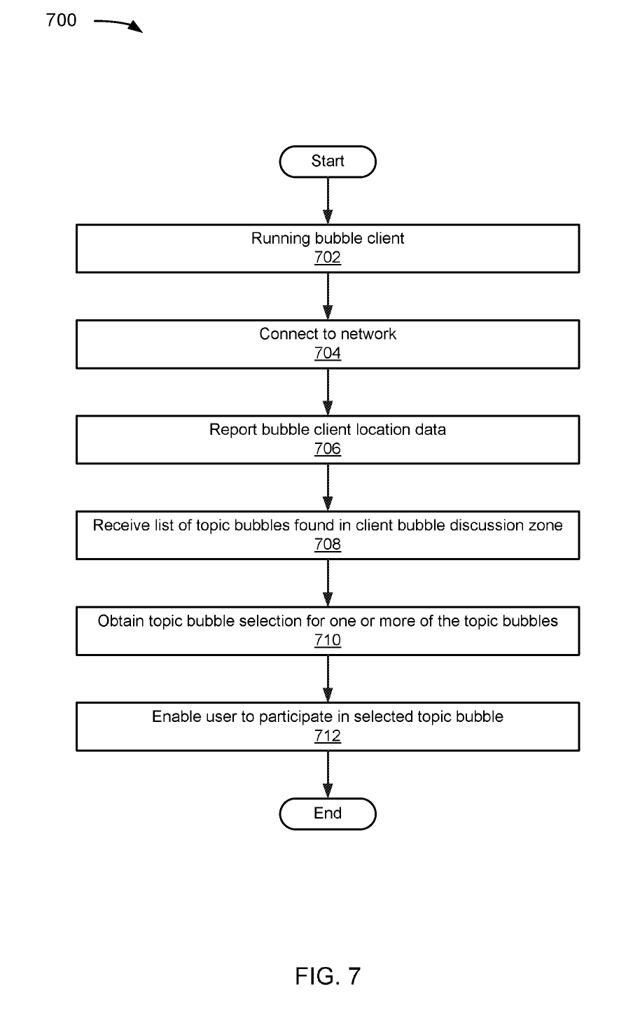

FIG. 7 depicts a flowchart 700 of an example of a method for joining a topic bubble. In the example of FIG. 7, the flowchart 700 starts at module 702 with running a bubble client. The bubble client is an engine that is capable of acting as a client to a bubble server. Running a bubble client can entail turning on a machine that is preconfigured or can autoconfigure itself to act as a bubble client. In a specific implementation, running a bubble client entails starting a bubble application that has been installed or is streamed to a mobile device.

In the example of FIG. 7, the flowchart 700 continues to module 704 with connecting to a network. In a specific implementation, the bubble client is on a mobile device that connects to a wireless network, which is, in turn, connected to a (usually wired) backbone network.

In the example of FIG. 7, the flowchart 700 continues to module 706 with reporting bubble client location data. Prior to sending the bubble client location data, there may or may not be a login or other procedure (not shown). In a specific implementation, the bubble client can obtain a discussion zone radius from a user of the bubble client, which is also reported with the bubble client location data. Alternatively, a bubble server could assign a discussion zone to the client based on account information, host preferences, etc., without or in addition to receiving the user-selected discussion zone radius from the bubble server.

In the example of FIG. 7, the flowchart 700 continues to module 708 with receiving a list of topic bubbles found in a client bubble discussion zone. The discussion zone can be calculated in a manner that is described later. The bubble client can see bubbles that are within range and that are appropriate (e.g., the client bubble has the requisite permissions to join) for the user of the bubble client. In a specific implementation, the bubbles can be sorted by topic, host rating, popularity (e.g., number of messages, number of participants, etc.), or in some other applicable manner. The bubble client may or may not have text-based or category-based search capabilities to find bubbles by topic, within range, nearby, that have been joined by the user, etc.

In the example of FIG. 7, the flowchart 700 continues to module 710 with obtaining topic bubble selection for one or more of the topic bubbles. Obtaining the topic bubble selection can entail providing a user interface for a user of a device, and receiving the relevant selection through the user interface. Alternatively, a user may be able to set bubbles having certain parameters to “auto-join.” For example, if a topic includes certain keywords, or is categorized in a certain way, a user may wish to participate in the bubble automatically.

In the example of FIG. 7, the flowchart 700 continues to module 712 with enabling a user to participate in a selected topic bubble. After a user joins a topic bubble, the user can participate in a manner that is appropriate for the user, the implementation, the configuration, and/or the embodiment. For example, some topic bubbles may be set up for IM communications between participants. The flowchart 700 ends at this point, but could alternatively repeat from one or more of the modules (e.g., a user could select additional topic bubbles from the list of topic bubbles (710), the bubble client could report new bubble client location data (706) and receive a new list of topic bubbles (708), the list of topic bubbles could be updated as new bubbles are created (708), the mobile device could roam to a new network or reconnect to a network (704), etc.).

It may be desirable to provide a list of bubbles that the bubble client has already joined, or indicate which of the bubbles in the list of bubbles (result list) are joined. It may further be desirable to enable sorting of the bubbles by topic, rating of the host, popularity, etc.

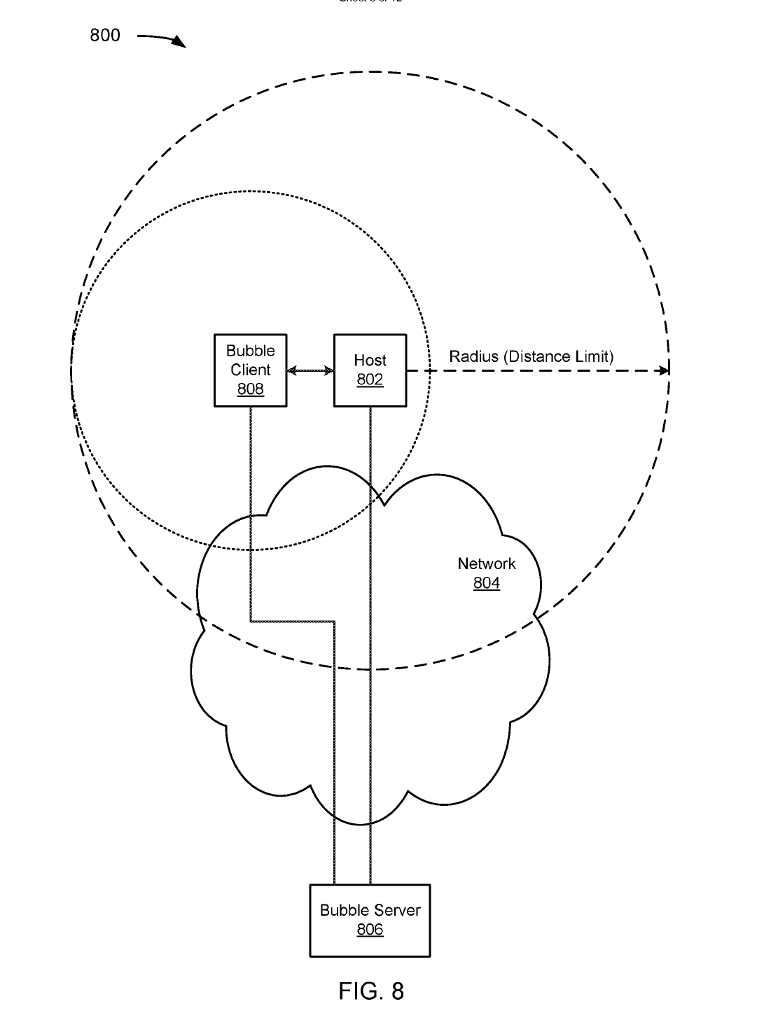

FIG. 8 depicts a conceptual diagram 800 of a bubble client joining a bubble. The diagram 800 includes a host 802, a network 804, a bubble server 806, and a bubble client 808. The host 802, network 804, and bubble server 806 can be implemented as described with reference to FIG. 5. In the example of FIG. 8, the bubble client 808 establishes a secured connection to the network 804 and sends location data and/or other parameters to the bubble server 806. The bubble server 806 calculates a discussion zone for the bubble client 808 and determines (at least in this example) that the bubble of the host 802 is within the discussion zone of the bubble client 808. The bubble server sends an identification of the bubble to the bubble client 808 (and may send additional bubbles, as well, which are ignored for the purpose of this example) via the secured network channel. The bubble client 808 can join the bubble and engage in discussion with other users, including the host, that are already participants of the bubble.

In the example of FIG. 8, the bubble client 808 is depicted as surrounded by a dotted circle. The dotted circle is intended to represent the bubble client's discussion zone. The dashed circle around the host 802, also representative of the topic bubble, is the host's discussion zone. In a specific implementation, for the bubble client 808 to join the bubble of the host 802, the bubble client 808 must be within the host's discussion zone and the host 802 must be within the bubble client's discussion zone. Alternatively, a system could be designed that calculates a match differently, such as if there is simply an overlap of discussion zones.

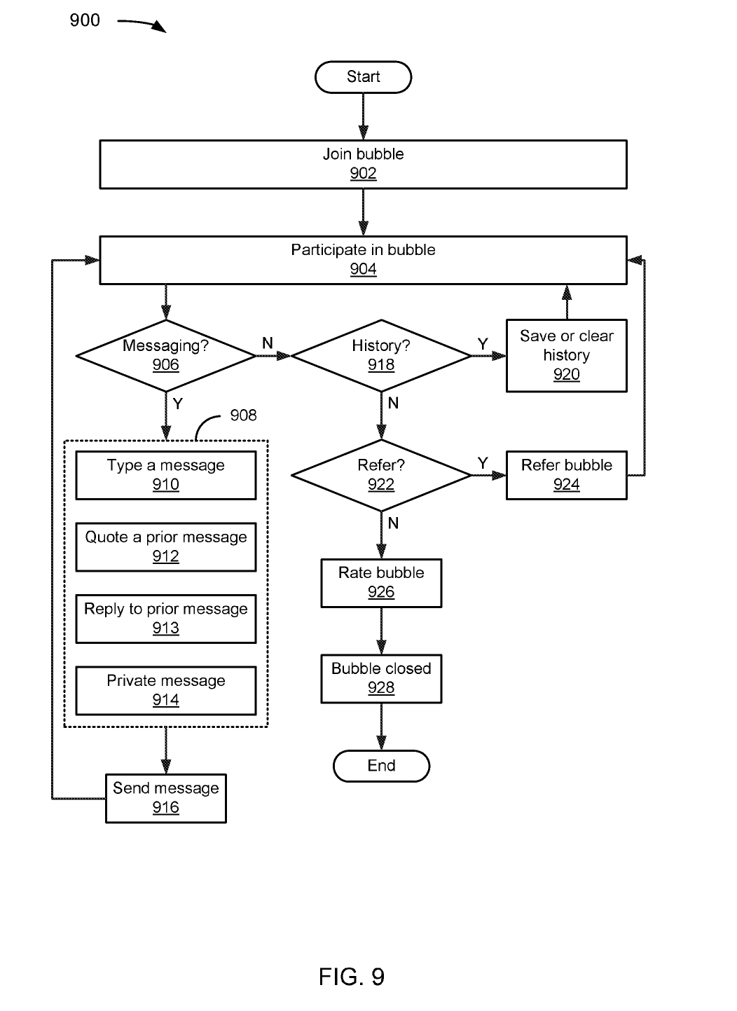

FIG. 9 depicts a flowchart 900 of an example of a method of participating in a bubble. In the example of FIG. 9, the flowchart 900 starts at module 902 with joining a bubble. The manner by which a bubble is discovered and joined is described elsewhere in this paper.

In the example of FIG. 9, the flowchart 900 continues to module 904 with participating in the bubble. In a specific implementation, participation in the bubble is via a user interface at a mobile device. The user interface can be a graphical user interface (GUI), a voice interface, or some other applicable interface. When participating in the bubble, a user can choose from a variety of implementation and/or embodiment-specific options. This example includes messaging, history management (save and clear), and bubble management (refer and leave).

In the example of FIG. 9, the flowchart 900 continues to decision point 906 where it is determined whether the participation is in the form of messaging. If it is determined that the participation is in the form of messaging (906-Y), then the flowchart 900 continues to module 908 where various messaging activities can be carried out. For example, a user can type a message 910, quote a message (which may or may not be part of replying to the quoted message) 912, reply to a prior message 913, or private messaging (PMing) another bubble participant 914. The flowchart 900 continues to module 916 where the message is sent to the other bubble participants (or a subset thereof if PMing) and the flowchart 900 returns to module 904 and continues as described previously.

Referring once again to decision point 906, if it is determined that the participation is not in the form of messaging (906-N), then the flowchart 900 continues to decision point 918 where it is determined whether the participation is in the form of history management. If it is determined that the participation is in the form of history management (918-Y), then the flowchart 900 continues to module 920 where the history is saved (presumably for provisioning to the user that saved it) or cleared, and the flowchart 900 returns to module 904 and continues as described previously.

If, on the other hand, it is determined that the participation is not in the form of history management (920-N), then the flowchart 900 continues to decision point 922 where it is determined whether the participation is in the form of a bubble referral. If it is determined that the participation is in the form of a bubble referral (922-Y), then the flowchart 900 continues to module 924 with referring the bubble to another user. The user can be a bubble client (internal) or the user can not yet be a bubble client (external), which means the referral includes an implicit request to become a bubble client.

If, on the other hand, it is determined that the participation is not in the form of a bubble referral (922-N), then the flowchart 900 continues to module 926 with rating the bubble. The rating can reflect on the rating of the host. The flowchart 900 ends module 928 where the bubble is closed. It may be noted that if there are additional ways to participate in the bubble, some other decision point could be inserted after decision point 922.

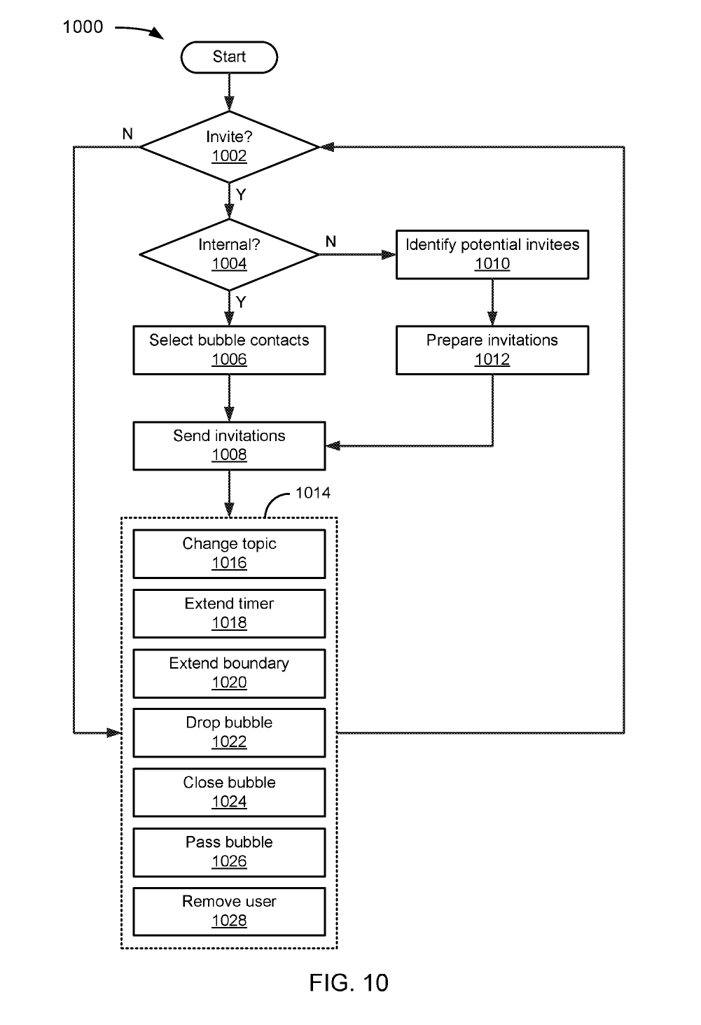

FIG. 10 depicts a flowchart 1000 of an example of a method of host bubble management. In the example of FIG. 10, the flowchart 1000 starts at decision point 1002 where it is determined whether to invite bubble participants. If it is determined that bubble participants are being invited (1002-Y), then the flowchart 1000 continues to decision point 1004 where it is determined whether the invitations are to internal contacts. For the purpose of this example, internal contacts are bubble client contacts.

If it is determined that invitations are to internal contacts (1004-Y), then the flowchart 1000 continues to module 1006 where bubble contacts are selected. Bubble contacts can include contacts that a host already knows, or bubble contacts who happen to fall within the discussion zone of the bubble. In a specific implementation, bubble contacts can have privacy settings that prevent their being listed for certain hosts. For example, a bubble contact, assuming a specific implementation allows, could have a privacy setting that prevents them from being contacted by anyone who is not a contact on another list (e.g., an address list) or that prevents previously black-listed bubble contacts from inviting them to a new bubble. For those bubble contacts that are visible to a host, the bubble contacts can be selected in an applicable manner, such as checking boxes next to the bubble contact ID in a bubble contact list. The flowchart 1000 continues to module 1008 with sending the invitations when the bubble contacts have been selected.

Referring once again to decision point 1004, if it is determined that invitations are not to internal contacts (1004-Y), then the flowchart 1000 continues to module 1010 with identifying potential invitees. Invitees can be identified using the host's contact lists or by finding the potential invitees through some other manner (e.g., by reading a business card, looking the potential invitee up in a phone book, etc.). The flowchart 1000 continues to module 1012 with preparing the invitations to send to the external contacts. Preparation can be by a number of different media, such as email, SMS, or some other applicable communication medium. The flowchart 1000 continues to module 1008 with sending the invitations when the non-bubble clients have been selected.

After module 1008, the flowchart 1000 continues to module 1014. Also, referring once again to decision point 1002, if it is determined that bubble participants are not being invited (1002-N), then the flowchart 1000 continues to module 1014.

The flowchart 1000 continues to module 1014 where the properties and other management features can be carried out. The features can include changing the bubble topic 1016, extending a timer 1018 for a bubble that is set to expire after a time, extending the bubble's boundary 1020, dropping (or anchoring) the bubble 1022, closing the bubble 1024 (which immediately destroys the bubble), passing the bubble to a new host 1026, or kicking out users 1028 such that they cannot return to this bubble. Optionally, users that are kicked out can be black-listed from future bubbles that the host creates. The flowchart 1000 then returns to decision point 1002 as described previously.

In a specific implementation, it is not necessary to explicitly invite bubble contacts or non-bubble contacts to join a bubble. In such an implementation, bubble clients that are within the discussion zone of the bubble, and whose discussion zone sufficiently covers the bubble, can join the bubble. Of course, non-bubble clients may have to be invited explicitly (or else the non-bubble clients could download a bubble application and find the bubble themselves).

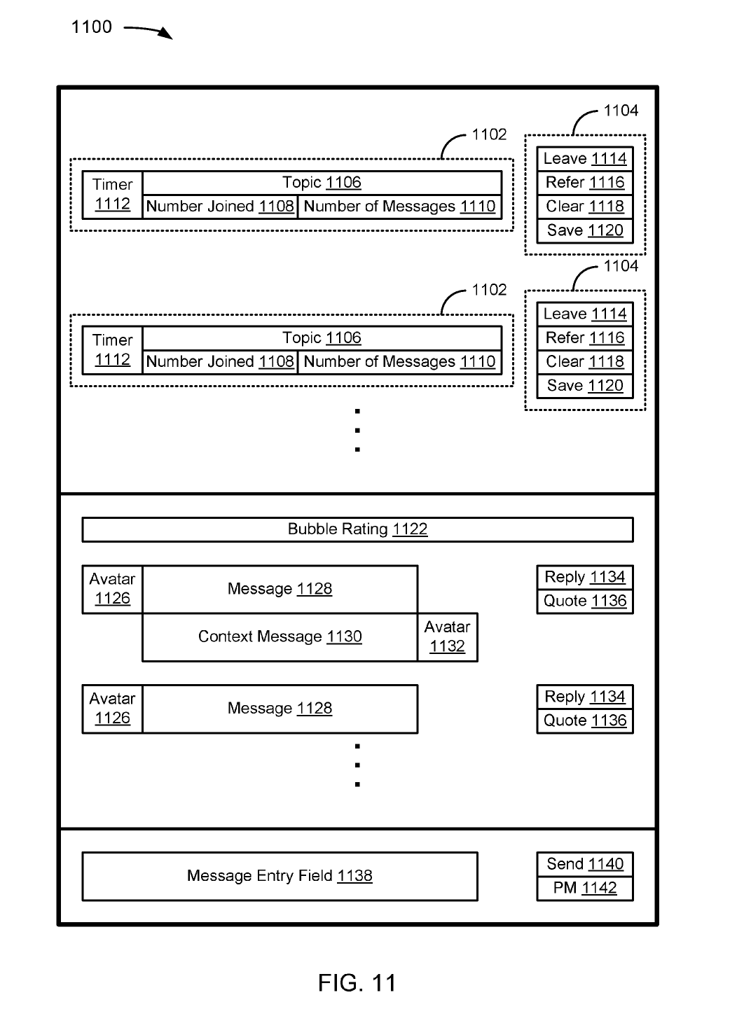

FIG. 11 depicts a conceptual diagram 1100 of a bubble interface. FIG. 11 is intended to illustrate an example of how a bubble interface might be formed for a user. The bubble interface can be modified to more effectively carry out techniques described in this paper or for other reasons. The diagram 1100 includes a topic bubble field 1102 and topic bubble buttons 1104. The topic bubble field 1102 includes a topic field 1106, a number joined field 1108, a number of messages received field 1110, and a timer 1112. The number joined and the number of messages received may or may not effect the bubble rating for the bubble. The timer is indicative of the amount of time that remains before the bubble expires (this time can be extended by the host in a specific implementation). The topic bubble buttons 1104 include a leave button 1114, a refer button 1116, a clear button 1118, and a save button 1120. If the user selects the leave button, the relevant topic bubble is removed from the list. If the user selects the refer button, the user can refer the bubble to a bubble contact or non-bubble contact. If the user selects the clear button, the user can wipe the message history for the bubble. If the user selects the save button, the user can save the message history (e.g., for sending to the user via email). The placement of the buttons is purely illustrative (they could also be placed next to the message history in the second frame). When a new message is sent to a topic bubble, an alert can flash/sound (e.g., the number of messages can be highlighted, flashing, etc. or an icon can be displayed indicating there are new messages). Similarly, when a new participant joins, an alert can flash/sound. The user can be alerted when a new bubble is created, as well.

The second frame includes a bubble rating field 1122, an avatar 1126, a message field 1128, a context message 1130, an avatar 1132, a reply button 1134 and a quote button 1136. The contents of the second frame can correspond to a topic bubble that is selected in the first frame. The bubble rating field 1122 can correspond to the popularity of the bubble (by number of messages or number of participants), the rating of the host, or some other metric. The avatar 1126 corresponds to the user responsible for the message in the message field 1128 and the avatar 1132 corresponds to the user responsible for the context message 1130. If the user selects the reply button 1134, the user can enter a message that includes a context message (e.g., the message for which a reply is created). The user can also select the quote button 1136 to quote a message.

The third frame includes a message entry field 1138, a send button 1140, and a PM button 1142. The user can enter a message in the message entry field 1138 and send to the bubble by pressing the send button or send to an individual (or a subset of the bubble) using the PM button.

It should be noted that the fields and buttons are for illustrative purposes only. There are many ways to carry out the intended functionality of the interface without using the fields and buttons depicted. For example, a user could click on an avatar, write a message, and click send to send a PM (obviating the need for an actual PM button). There can be other functionality, as well, such as a button that enables a participant to be added to a contact list of the user. The amount of information available should be configurable by the user from whom the contact information is being obtained. For example, a salesman may wish to make contact information freely available, while a private citizen may wish to hide some personal information.

In a specific implementation, the business card of a user can be made available to bubble participants. By clicking on the business card, which can be graphical or text, the contact information can be saved to a participant's contact list. This can enable users to share information to certain groups. Because the bubbles are location-specific, certain businesses may be interested in sharing information in relevant bubbles regarding local offerings.

In a specific implementation, user information can be saved. This can include information about with whom contact information is shared and from whom contact information is obtained. Basically, the when, where, who, and which group (topic) can be saved.

In a specific implementation, within a certain distance, customers can set what kind of flyers they are interested in receiving (e.g., in a street mall, related to certain items (e.g., clothing or drinks), known shop names or types, guilds, discounts, etc.). Shops can create flyers to send to interested customers automatically when the customer comes within range. In a specific implementation, the business keeps the bubble open during business hours, during happy hour, or for some other relevant duration.

As has been previously described, bubbles can be limited by distance and time. Bubbles can also be limited by number of words on a per-user or aggregate basis, number of messages, or number of participants. It may be desirable to wipe bubble history when duration, number of words, or the like are extended. It may be desirable to password protect a bubble, depending upon the needs of the host and/or implementation. Upon being kicked out, a user can be black-listed for the topic and/or host, or the user can be put on a timer until the timer expires (enabling the user to join topics again).

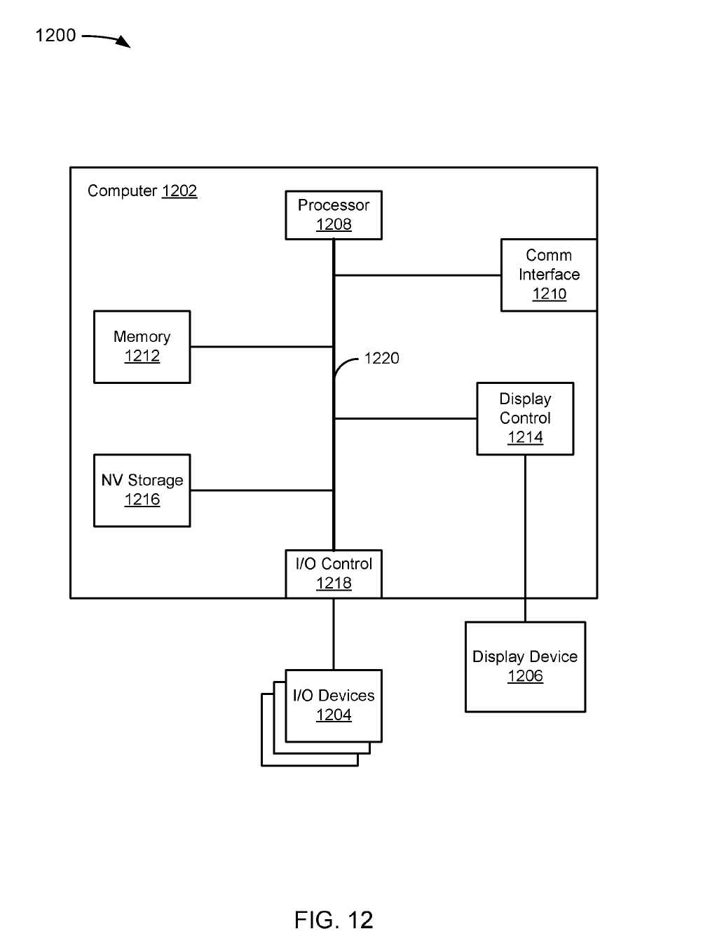

FIG. 12 depicts an example of a computer system 1200 on which techniques described in this paper can be implemented. The computer system 1200 may be a conventional computer system that can be used as a client computer system, such as a mobile device, a wireless client or a workstation, or a server computer system. The computer system 1200 includes a computer 1202, I/O devices 1204, and a display device 1206. The computer 1202 includes a processor 1208, a communications interface 1210, memory 1212, display controller 1214, non-volatile storage 1216, and I/O controller 1218. The computer 1202 may be coupled to or include the I/O devices 1204 and display device 1206.

The computer 1202 interfaces to external systems through the communications interface 1210, which may include a modem or network interface. It will be appreciated that the communications interface 1210 can be considered to be part of the computer system 1200 or a part of the computer 1202. The communications interface 1210 can be an analog modem, ISDN modem, cable modem, token ring interface, satellite transmission interface (e.g. “direct PC”), or other interfaces for coupling a computer system to other computer systems.

The processor 1208 may be, for example, a conventional microprocessor such as an Intel Pentium microprocessor or Motorola power PC microprocessor. The memory 1212 is coupled to the processor 1208 by a bus 1270. The memory 1212 can be Dynamic Random Access Memory (DRAM) and can also include Static RAM (SRAM). The bus 1270 couples the processor 1208 to the memory 1212, also to the non-volatile storage 1216, to the display controller 1214, and to the I/O controller 1218.

The I/O devices 1204 can include a keyboard, disk drives, printers, a scanner, and other input and output devices, including a mouse or other pointing device. The display controller 1214 may control in the conventional manner a display on the display device 1206, which can be, for example, a cathode ray tube (CRT) or liquid crystal display (LCD). The display controller 1214 and the I/O controller 1218 can be implemented with conventional well known technology.

The non-volatile storage 1216 is often a magnetic hard disk, an optical disk, or another form of storage for large amounts of data. Some of this data is often written, by a direct memory access process, into memory 1212 during execution of software in the computer 1202. One of skill in the art will immediately recognize that the terms “machine-readable medium” or “computer-readable medium” includes any type of storage device that is accessible by the processor 1208 and also encompasses a carrier wave that encodes a data signal.

The computer system 1200 is one example of many possible computer systems which have different architectures. For example, personal computers based on an Intel microprocessor often have multiple buses, one of which can be an I/O bus for the peripherals and one that directly connects the processor 1208 and the memory 1212 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 1212 for execution by the processor 1208. A Web TV system, which is known in the art, is also considered to be a computer system, but it may lack some of the features shown in FIG. 12, such as certain input or output devices. A typical computer system will usually include at least a processor, memory, and a bus coupling the memory to the processor.

In addition, the computer system 1200 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 1216 and causes the processor 1208 to execute the various acts required by the operating system to input and output data and to store data in memory, including storing files on the non-volatile storage 1216.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

Although the foregoing embodiments have been described in some detail for purposes of clarity of understanding, the invention is not limited to the details provided. There are many alternative ways of implementing the invention. The disclosed embodiments are illustrative and not restrictive.

We claim:

1. A system comprising:
a bubble management engine;
a client management engine coupled to the bubble management engine;
wherein, in operation:
the client management engine obtains a bubble client discussion zone parameter for a bubble client;
the bubble management engine compares the bubble client discussion zone parameter to active bubble discussion zones;
the bubble management engine creates a list of bubbles that have active bubble discussion zones overlapping the bubble client discussion zone;
the bubble management engine receives a selection of an active bubble from the list of bubbles;
the bubble management engine records the bubble client as a participant in the bubble.

2. A method comprising:
obtaining a topic parameter;
obtaining a boundary parameter;
establishing a secure connection with a wireless network;
sending the topic parameter and the boundary parameter via a secure channel;
receiving confirmation of topic registration via a secure channel;
wherein a topic bubble having a topic derived at least in part from the topic parameter within a boundary derived at least in part from the boundary parameter can be joined by bubble clients within the boundary.

3. The method of claim 2 wherein the boundary parameter is a radial distance to a circle surrounding a host location.

4. The method of claim 2, further comprising:
obtaining an anchor command;
sending an anchor request to a bubble server;
wherein a host location is replaced with an anchor location at a location within the topic bubble.

5. The method of claim 2 wherein the boundary parameter is a radial distance to a circle surrounding an anchor location.

6. The method of claim 2, further comprising:
obtaining a bubble application;
choosing an avatar and alias;
finishing registration.

7. The method of claim 2, further comprising:
identifying potential invitees;
preparing invitations to join the topic bubble for the potential invitees;
facilitating sending invitations to the potential invitees to become bubble clients and join the topic bubble.

8. The method of claim 2, further comprising:
receiving a selection of bubble contacts;
facilitating sending invitations to the selected bubble contacts to join the topic bubble.

9. The method of claim 2 further comprising taking an action selected from the group of actions consisting of changing a topic of the topic bubble, extending a timer of the topic bubble, extending the boundary of the topic bubble, dropping the topic bubble, closing the topic bubble, passing the topic bubble to another to serve as host, removing from the topic bubble a bubble client who is in the topic bubble.

10. A method comprising:
running a bubble client;
connecting to a network;
reporting bubble client location data;
receiving a list of topic bubbles found in a client bubble discussion zone;
obtaining a topic bubble selection for one or more of the topic bubbles;
enabling a user to participate in the selected topic bubble.

11. The method of claim 10 wherein the client bubble discussion zone encompasses a host location and a host discussion zone encompasses a device running the bubble client.

12. The method of claim 10 wherein the client bubble discussion zone and a host discussion zone overlap.

13. The method of claim 10 wherein enabling a user to participate in the selected topic bubble includes:
receiving messaging content;
sending a message including the messaging content to bubble clients that are in the topic bubble.

14. The method of claim 10 wherein enabling a user to participate in the selected topic bubble includes:
receiving messaging content;
sending a private message including the messaging content to a bubble client that is in the topic bubble.

15. The method of claim 10 wherein enabling a user to participate in the selected topic bubble includes saving a topic bubble message history or clearing a topic bubble message history.

16. The method of claim 10 wherein enabling a user to participate in the selected topic bubble includes referring the topic bubble to another.

17. The method of claim 10 wherein enabling a user to participate in the selected topic bubble includes receiving a rating associated with the bubble and closing the bubble for the user.
